(19) United States
(12) Patent Application Publication
(10) Pub. No.: US 2002/0120573 A1
(43) Pub. Date: Aug. 29, 2002

(54) Secure extranet operation with open access for qualified medical professional

(76) Inventor: Douglas McCormick, Wynnewood, PA (US)

Correspondence Address: Groover & Associates P.C., Suite 230, 17000 Preston Road, Dallas, TX, 75248, US

(21) Appl. No.: 09/821,777

(22) Filed: Mar. 29, 2001

Related U.S. Application Data
(63) Continuation of application No. 09/248,308, filed on Feb. 11, 1999.
(63) Continuation of application No. PCT/US99/22253, filed on Sep. 24, 1999.
(63) Continuation of application No. 09/405,198, filed on Sep. 24, 1999, now abandoned.
(63) Continuation of application No. 09/405,197, filed on Sep. 24, 1999, now abandoned.
(63) Continuation of application No. 09/405,814, filed on Sep. 24, 1999.
(60) Provisional application No. 60/195,363, filed on Apr. 6, 2000.
(60) Provisional application No. 60/106,838, filed on Nov. 3, 1998.

(51) Int. Cl. G06F 17/60

(52) U.S. Cl. 705/50; 705/1; 705/2

(57) ABSTRACT

A business method of verifying status of health care professionals for entry to limited access areas of Web sites. Users are not required to be preregistered, and can gain access by entering identifiers which are checked against American Medical Association records.

### CROSS-REFERENCE TO OTHER APPLICATION

This application claims priority from U.S. Provisional Application 60/106,838 Filed Nov. 3, 1998 and from U.S. Non-provisional application 09/248,308 Filed Feb. 11, 1999, both of which are hereby incorporated by reference.

### BACKGROUND AND SUMMARY OF THE INVENTION

The present invention relates to authentication of computer users requesting controlled information in distributed environments. Particularly, the present invention relates to remote authentication of physicians requesting controlled information across the Internet.

Background: Pharmaceutical and Medical Device Information

Communication of professional information in the health care industries is (quite literally) vital, and yet there are severe problems in the legal system which make frank communication among physicians difficult and/or dangerous.

Background: Medical Liability

A significant problem with physician communications, in the United States, is that doctors and medical care organizations are a favorite target of predatory lawyers. The exposure to lawsuits is so high that liability insurance rates are a major factor in determining the economic viability of professional practices. Consequently, the recommendations of medical insurance companies may be impossible for health care professionals to resist. In this environment any vulnerability which makes it easier for physicians and health care organizations to be attacked by frivolous lawsuits is extremely unwelcome. For this reason, it is undesirable to have physician communications with the vendors of health care products be open for snooping. The necessity for health care professionals to watch every word of communication, out of concern for attack by frivolous lawsuits, puts a significant damper on a physician's ability to gain access to new medical information, or to openly discuss case studies with colleagues.

Background: Patient Confidential Information

Health care professionals are constrained in their ability to discuss and release patient confidential information. Such information is usually protected by doctor patient confidentiality because of its extremely sensitive nature. In many jurisdictions a health care professional may be held liable to the patient if the health care professional allows such information to escape. Nevertheless, such sensitive information is often relevant to discussions of the cases faced by physicians. Even without the patient's name attached, the complete set of patient data may be such as to indicate the identity of the patient and thus permit the escape of sensitive information to a careful snooper. Thus the physician's legal environment is constrained both by the need to obtain new information which may relate to the existing cases, and by the severe legal dangers to the physician in openly transmitting such information.

Background: Federal Regulations

Distribution of information on pharmaceuticals and medical devices is potentially subject to regulation by the U.S. Food and Drug Administration (or “The FDA”). Currently the FDA maintains that its rules do not distinguish between promotion aimed at lay persons and those aimed at health care professionals. However, in practice, the FDA applies stricter standards to communications aimed at the lay public than those aimed at “learned intermediaries” such as physicians. In addition to U.S. regulations, other non-U.S. national regulatory agencies currently maintain bans on direct-to-consumer advertising. According to the World Health Organization (WHO), direct consumer promotion of prescription drugs is illegal except in the United States and Morocco.

Background: Marketing

The pharmaceutical industry spends more than $15 billion annually marketing to physicians in the United States. Spending on sales and marketing grows every year by almost 10%. Additionally, the 800 member companies which make up the Health Care Industry Marketing Association (an association of medical device manufacturers) spend about $13 billion a year in attempts to reach physicians with information on regulated products.

Currently, pharmaceutical companies utilize several strategies to communicate information about their products to physicians. One such strategy is the use of pharmaceutical representatives to directly contact physicians at their offices. Visits by pharmaceutical representatives typically cost pharmaceutical companies $125-$350 per interaction with a physician.

Another strategy used by pharmaceutical companies is the use of telemarketing. This strategy has grown to include reverse communications in which a physician is issued an “invitation code” (or “access code”). The code is used to access lectures concerning the latest treatments and protocols over the phone. Even then, each interaction by telemarketing costs between $10 and $50.

Finally, pharmaceutical companies resort to direct mail. However, direct mail can still result in a per physician cost of $10-$30 each. Furthermore, direct mail is the least reliable of the current strategies. It cannot be determined who is actually reached with direct mail advertising. This uncertainty is particularly true if the provider has appointed a staff member to read and sort mail. Even if the mail does reach its intended target, the amount of time that the doctor actually spends with the information and the impact of the information on the doctor's decision making cannot be accurately determined.

Background: Internet Marketing

Health care reform pressures manufacturers of pharmaceuticals and medical devices to bring down the cost of health care. At the same time, the owners or shareholders of such companies create internal pressure to increase profit margins and reduce costs. Marketing expenditures also affect health care costs. The Internet is expected to play a significant part in helping to reduce these marketing costs. The ten leading pharmaceuticals companies have had sites on tile world Wide Web since 1996.

In 1997, a study by Find/SVP found that approximately 35% of all American physicians had access to the Internet. This figure exceeded that of the general population which was then at 20%. Internet use among Americans continues to increase at a rate of about 80% per year. These figures suggest that connectivity will be the rule, especially among medical professionals, by the year 2000. Despite the exhibited trend, no pharmaceutical or medical device manufacturer yet uses its World Wide Web site as an important marketing tool for reaching physicians.

Physician's Online (POL) operates a market-sponsored Web site accessible by password. POL uses an advertising business model, producing mini-sites within its own Web site for each subscribing company. The result is high maintenance fees coupled with an absence of hands-on control of their information.

Background: The Internet

The Internet, which started in the late 1960's, is a vast computer network consisting of many smaller networks that span the entire globe. The Internet has grown exponentially, and millions of users ranging from individuals to corporations now use permanent and dial-up connections to use the Internet on a daily basis worldwide. The computers or networks of computers connected within the Internet, known as “hosts”, allow public access to databases featuring information in nearly every field of expertise and are supported by entities ranging from universities and government to many commercial organizations, including pharmaceutical companies.

The information on the Internet is made available to the public through “servers”. A server is a system running on an Internet host for making files or documents contained within that host available. Such files are typically stored on magnetic storage devices, such as tape drivers or fixed disks, local to the host. An Internet server is used to distribute information to a computer that requests the files on a host. The computer making such a request is known as the “client”, which may be an Internet-connected workstation, bulletin board system or home personal computer (PC).

Background: The World Wide Web (WWW)

The World-Wide Web (Web) is a method of accessing information on the Internet which allows a user to navigate the Internet resources intuitively, without IP addresses or other technical knowledge. The Web dispenses with command-line utilities which typically require a user to transmit sets of commands to communicate with an Internet server. Instead, the Web is made up of hundreds of thousands of interconnected “pages”, or documents, which can be displayed on a computer monitor. The Web pages are provided by hosts running special servers. Software which runs these Web servers is relatively simple and is available on a wide range of computer platforms including PC's. Equally available is a form of client software, known as a Web “browser”, which displays Web pages as well as traditional non-Web files on the client system.

Today, the Internet hosts which provide Web servers are increasing at a rate of more than 300 per month, en route to becoming the preferred method of Internet communication. Created in 1991, the Web is based on the concept of “hypertext” and a transfer method known as “HTTP” (Hypertext Transfer Protocol). HTTP is designed to run primarily over TCP/IP and uses the standard Internet setup, where a server issues the data and a client displays or processes it.

One format for information transfer is to create documents using Hypertext Markup Language (HTML). HTML pages are made up of standard text as well as formatting codes which indicate how the page should be displayed. The Web client, a browser, reads these codes in order to display the page.

Each Web page may contain pictures and sounds in addition to text. Hidden behind certain text, pictures or sounds are connections, known as “hypertext links” (“links”), to other pages within the same server or even on other computers within the Internet. For example, links may be visually displayed as words or phrases that may be underlined or displayed in a second color. Each link is directed to a Web page by using a special name called a URL (Uniform Resource Locator). URL's enable a Web browser to go directly to any file held on any Web server. A user may also specify a known URL by writing it directly into the command line on a Web page to jump to another Web page.

The URL naming system consists of three parts: the transfer format, the host name of the machine that holds the file, and the path to the file. An example of a URL is:

http://www.homepage.com/Adir/Bdir/Cdir/page.html

where “http” represents the transfer protocol; a colon and two forward slashes (://) are used to separate the transfer protocol from the host name; “www.homepage.com

” is the host name in which “www” denotes that the file being requested is a Web page; “/Adir/Bdir/Cdir” is a set of directory names in a tree structure, or a path, on the host machine; and “page.html” is the file name with an indication that the file is written in HTML.

Background: Internet Information Access

The Internet maintains an open structure in which exchanges of information are made cost-free without restriction. The free access format inherent to the Internet, however, presents difficulties for those information providers requiring control over their Internet servers. Consider, for example, a research organization that may want to make certain technical information available on its Internet server to a large group of colleagues around the globe, but the information must be kept confidential. Without means of identifying each client, the organization would not be able to provide information on the network on a confidential or preferential basis. In another situation, a company may want to provide highly specific service tips over its Internet server only to customers having service contracts or accounts.

Access control by an Internet server is difficult for at least two reasons. First, when a client sends a request for a file on a remote Internet server, that message is routed or relayed by a Web of computers connected through the Internet until it reaches its destination host. The client does not necessarily know how its message reaches the server. At the same time, the server makes responses without ever knowing exactly who the client is or what its IP address is. While the server may be programmed to trace its clients, the task of tracing is often difficult, if not impossible. Secondly, to prevent unwanted intrusion into private local area networks (LAN), system administrators implement various data flow control mechanisms, such as Internet “firewalls”, within their networks. An Internet firewall is a software structure which allows a user to reach the Internet while preventing intruders of the outside world from accessing the user's LAN.

Background: On-line Transaction Security

The ease with which services and users are able to find each other and the convenience associated with on-line transactions is leading to an increase in the number of remote business and related transactions. However, users and services are not always certain who or what is at the other end of a transaction. Therefore, before they engage in business and other transactions, users and services want and need reassurance that each entity with whom they communicate is who or what it purports to be. For example, users will not be willing to make on-line purchases that require them to reveal their credit card numbers unless they are confident that the services with which they are communicating is in fact the service they wanted to access. Commercial and other private entities who provide on-line services may be more reluctant than individuals to conduct business on-line unless they are confident the communication is with the desired individual or service.

Both users and services need reassurance that neither will compromise the integrity of the other and that confidential information will not be revealed unintentionally to third parties while communications are occurring. Security in a global network, however, may be difficult to achieve for several reasons. First, the connections between remote users and services are dynamic. With the use of portable devices, users may change their remote physical locations frequently. The individual networks that comprise the global networks have many entry and exit points. Also, packet switching techniques used in global networks result in numerous dynamic paths that are established between participating entities in order to achieve reliable communication between two parties.

Finally, communication is often accomplished via inherently insecure facilities such as the public telephone network and many private communication facilities. Secure communication is difficult to achieve in such distributed environments because security breaches may occur at the remote user's site, at the service computer site, or along the communication link. Consequently, reliable two-way authentication of users and services is essential for achieving security in a distributed environment.

Background: Intranets and Extranets

An intranet is a smaller version of the internet that is limited to connections within an organization. Access is limited to the members of the organization, usually by means of a firewall. A firewall acts as a gateway that stems the flow of data into and out of the intranet.

An extranet is an intranet that extends access to specific users beyond the firewall. For instance, a company's intranet may be accessible from remote locations that are not physically on the company premises. A company's catalog and product information, but no other company data, may be accessible to customers. Access to extranets often requires passing a gatekeeper of some sort that only allows access to users with specific information (e.g., a password).

Generally, users can interact on both intranets and extranets by means of the same user-friendly browsers that allow internet access.

Background: Authentication

Two-way authentication schemes generally involve hand-shaking techniques so that each party may verify he or she is in communication with the desired party regardless of each party's location or the types of devices in use. The problem to be solved is one in which a user communicates with a service that wishes to learn and authenticate the user's identity and vice versa. To clarify the problem, there are three aspects of network security that may be distinguished. Identification: the way in which a user or service is referenced. Authentication: the way in which a user may prove his or her identity. Authorization: a method for determining what a given user may do. The latter two aspects apply to service providers as well as to users.

Background: Identification

A user's identity usually consists of a user name and a realm name. A realm is a universe of identities. CompuServe Information Serve (CIS) and America Online (AOL) screen names are two examples of realms. The combination of user name and realm, typically shown as name@realm, identifies a user. Any given service recognizes some particular set of identities. A realm does not have to be large either in number of users or size of service. For example, a single WWW server may have its own realm of users.

Background: Internet Authentication

Authentication provides the ability to prove identity. When asking to do something for which a user's identity matters, the user may be asked for his or her identity. The service then usually requires the user to prove that identity. To accomplish this, most services use a separate character string as a password. The password is intended to be kept confidential. If the password given for a particular identity is correct, the user is authenticated. Of course, there are some methods of authentication which are much more strict than a username/password regime, e.g., challenge/response type systems. However, a password system is generally reliable for communications in which a medium level of trustworthy authentication is tolerable.

Background: Internet Authorization

Authorization refers to the process of determining whether a given user is allowed to do something. For example, may the user post a message, or use a confidential service? It is important to realize that authentication and authorization are distinct processes. One relates to proving an identity and the other relates to the properties of an identity.

Background: Internet Pass Phrase

A service that wishes to authenticate a user requires the user to identify himself or herself and to prove that he or she knows the pass-phrase. Generally, the service prompts the user for the pass-phrase. However, transmitting the plain text pass-phrases through a network compromises security because an eavesdropper may learn the pass-phrase as it travels through the network. X.25 networks have been compromised, and LANs, modem pools, and “The Internet” likewise are not suitable for plain text pass-phrases due to the eavesdropper problem. Prompting for the pass-phrase, while sufficient in the past, no longer works for extensive world-wide networks.

Background: Internet Encryption

A protocol exists for secure transactions across the Internet. The Secure Sockets Layer (or “SSL”) was designed by Netscape Communications to enable encrypted, authenticated communications across the Internet. SSL is used mostly (but not exclusively) in communications between Web browsers and Web servers. SSL provides 3 important things: privacy, authentication, and message integrity. An SSL connection requires each side of the connection to have a Security Certificate, which it sends to the other. Each side then encrypts what it sends using information from both its own and the other side's Certificate, ensuring that only the intended recipient can decrypt it (privacy), and that the other side can be sure of the origin of the data (authentication), and that the message has not suffered tampering (message integrity).

Background: Sales Contacts

Salesmen play a crucial role in many areas of commerce. Economic theory may treat buyers' decisions as rational, but in practice buying decisions are affected by human contact as well as by rational considerations. (Humans are social animals by nature, and not merely logical processes.) Thus face-to-face contact with salesmen is not only a tool for spreading information, but also a way to provide the reassuring contact which is part of normal decision-making. This aspect of sales becomes more important in areas where the price of each individual purchase is large, or the cost of possible errors is high, or the pool of qualified buyers is subjected to extensive sales pressure from competing vendors. Marketing to physicians meets the last two of these criteria, and sometimes meets the first criterion as well (for purchases of capital equipment).

The importance of human contact in the buying process is discussed in the extensive literature on selling; see, e.g., The Sales Bible by Jeffrey Gitomer, and the numerous books cited therein, all of which are hereby incorporated by reference. As these books discuss, one of the important steps in the process is simply getting a chance to establish a friendly initial contact with the buyer. As these books also discuss extensively, buyers often prefer not to be bothered, and erect various barriers to such initial contact.

In some areas of e-commerce information dissemination must be restricted (as discussed above), and this presents a dilemma which has remained unsolved. If buyers must provide identification before getting information, they expose themselves to aggressive sales tactics (such as unwanted phone calls or emails). When wary buyers decline to provide identification, then those buyers will not receive information provided by the seller, even though that information would benefit both buyer and seller. This is inefficient. The present application discloses a new way to address this dilemma.

Remote Physician Authentication Service

The present application discloses a method and system of remote verification of an end user of a Web page with controlled access. Users are issued a username and password which can be used to access any site which subscribes to the described verification system. In practice, a user connects to a Web site which contains desired information. When the user attempts to enter an area (or page) of the site with controlled access, the pre-issued user name and password are requested. Once this information is entered, the subscribing Web site sends a secure (encrypted) query to a remote password database server. The supplied information is checked against a verification database. A yes or no verification is sent back to the subscribing site. The verification can also include anonymous demographic information such as specialty, location, and type of practice. The subscribing site then acts upon the verification received. The information entered by the user, while sent by the subscribing site, is not accessible by the subscribing site. Thus, the site cannot create its own database of pre-verified users and the health care professional remains in control of his or her information.

The password verification process requires that the user be pre-registered with the verification service. Registration allows the user to be entered into a database and assigned an identification and password. These identifiers, when supplied by the user, are matched on the PVS server for verification. However, a more flexible method of verification that does not require pre-registration can also be used, as disclosed in the embodiments of the present invention. A U.S. physician who has not received a PVS username and password can complete the Rapid Registration Form, which prompts the physician for personal data. This personal data is matched against the masterfile of all U.S. physicians held by the American Medical Association. Correct entry of the requested personal data achieves verification. The Rapid Registration also allows the physician to request a PVS username and password so that the usual verification process, i.e., comparison with the username and password on the PVS password server, can be used on later visits to PVS subscribing Web sites.

There are many advantages to the disclosed business method. It offers health care marketers confidence that they are in complete compliance with rules that restrict or prohibit promoting prescription drugs to the general public. Patient confidentiality is maintained and the health care professional may research specific protocols, drugs, and treatments. Malpractice liability under learned-intermediary tort law is reduced. The disclosed business method also opens direct-to-physician communication on the Web without incurring FDA limits on direct consumer communication.

The disclosed business method also provides a verification service to device marketers at a price substantially lower than the cost of creating such a utility in-house. Registration screens, discouraging to much potential Web site traffic, are avoided. Also, a storehouse of physician information can be established, and publishers and health care communicators can gauge their audiences more carefully. Clinical trials managers can communicate with potential physician investigators with the speed and cost-effectiveness of the internet and the confidence of the telephone or post. Also, medical educators can use this on-line medium for Continuing Medical Education.

### BRIEF DESCRIPTION OF THE DRAWINGS

The disclosed embodiments of the inventions will be described with reference to the accompanying drawings, which show important sample embodiments of the invention and which are incorporated in the specification hereof by reference, wherein:

FIG. 1 depicts a block diagram of the architecture of the Remote Verification System.

FIG. 2 depicts a flowchart of the method of remote verification.

FIG. 3 shows a block diagram of a computer system according to the presently preferred embodiment.

FIG. 4 shows the ISAPI Application Extension Process flowchart.

FIG. 5 shows the ISAPI Filter Process flowchart.

FIG. 6 shows a flowchart of the Rapid Registration Process, both with and without a PVS registered user.

FIG. 7 depicts an example “welcome” page as seen on the user's browser when they enter the PVS Internet site.

FIG. 8 shows an example “sign in” page for PVS users.

FIG. 9 shows a sample “pop-up” sales representative page, where the user's data allows the subscribing Web site to display the sales representative most likely to be encountered by the user.

FIGS. 10 and 11 show the how verification over the Internet can make ordering restricted access products easier.

### DETAILED DESCRIPTION OF THE PREFERRED EMBODIMENTS

The numerous innovative teachings of the present application will be described with particular reference to the presently preferred embodiment (by way of example, and not of limitation).

Definitions

Following are some of the technical terms which are used in the present application. Additional definitions can be found in the standard technical dictionaries.

Firewall: A security feature of Internet sites which is aimed at control of data flow.

HTML: Hypertext Markup Language. A format for information transfer made up of standard text as well as formatting codes which indicate how the page should be displayed in a browser.

HTTP: Hypertext Transfer Protocol. Designed to run primarily over TCP/IP using an Internet setup, where a server issues the data and a client displays or processes it.

Hpypertext: A method of linking certain text, pictures or sounds by connections, known as “hypertext links” (“links”), to other pages within the same server or even on other computers within the Internet.

SSL: Secure Sockets Layer. A protocol for secure and authenticated transactions over the Internet.

URL: Uniform Resource Locator. URL's enable a Web browser to go directly to any file held on any Web server.

Web: The World-Wide Web (Web) is a method of accessing information on the Internet which allows a user to navigate the Internet resources intuitively, without IP addresses or other technical knowledge.

X.25: A packet switching network protocol in which many connections are made over the same physical link.

Remote Physician Authentication

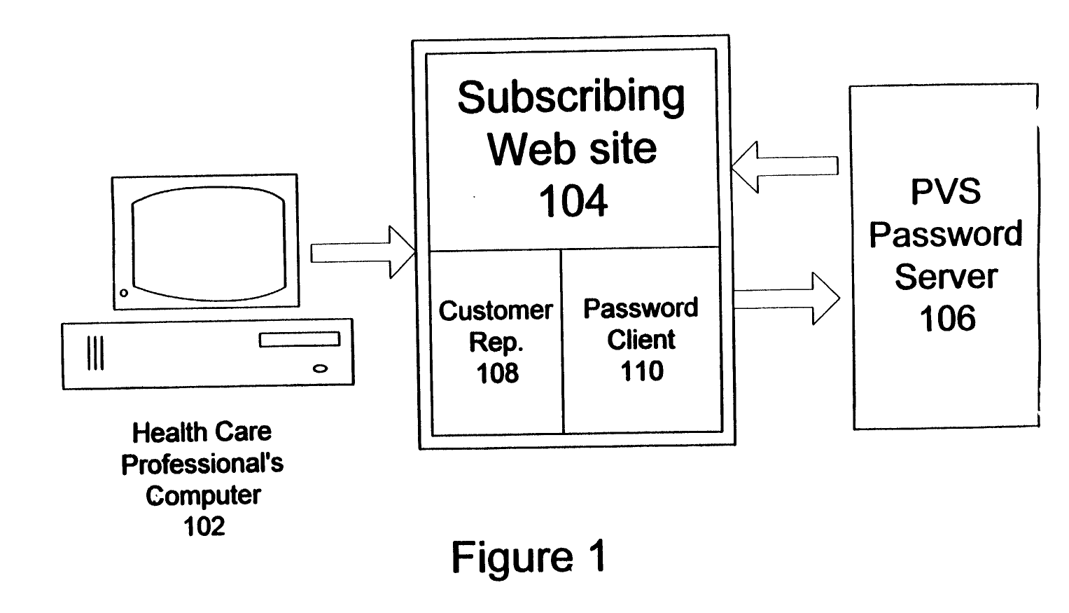

In the presently preferred embodiment, the remote authentication system consists of three components. FIG. 1 depicts a block diagram of the architecture of the Remote Verification System. The Remote Verification System acts as an Internet notary. Its function is to attest to the identity of incoming users to Web servers which control access to their information and can be positioned anywhere on the Internet.

Passwords

In the presently preferred embodiment, the system is designed to verify the passwords of health care professionals who seek entry into controlled access sites on the Internet. The term “health care professionals” includes not only physicians, but persons in other regulated or licensed occupations that rely on information concerning pharmaceuticals and medical devices. Such occupations include, for example, dentists, doctors of osteopathy, pharmacists, certain nurses, and other specialist occupations which may exist within the laws of the U.S. or other countries. Such sites can be provided by pharmaceutical companies as a marketing tool for new products and other information, and by medical societies as a service to members of their organizations. A user name and password combination is distributed in advance to verified health care professionals. Such information can be distributed via Internet, by mail, and/or by the sales force for a subscribing health care marketing organization. Typically this information comes from the American Medical Association's database of all U.S. physicians and other public record and professional society databases.

Remote Verification System

In the presently preferred embodiment, the health care professional (or “user”) uses a computer 102 to enter the Web site 104 of a health care marketer or professional education provider across a first channel of communications. A Web site of this sort will typically contain more than just health care professionals-only information. For example the site may contain employee rosters, human resource information, etc.

The system consists of several interlocking software elements, supported by routines running on the password verification server. The routines, Common Gateway Interface (or CGI) scripts, are installed on the subscriber's server to handle password and user-name submission transactions and mediate the interaction with the password verification server.

The user name and password are not needed until the user requests entry to a “health care professionals-only” segment of the site 104. At this point, the subscriber's Web site 104 requests the user's user name and password. The Customer Representative function 108 (an executable dwelling on the subscriber's site) is responsible for collecting the user's identifiers.

Upon receipt of the user's information, the subscriber's Web site 104 sends a secure query to a password verification server 106 via the Internet (or other telecommunications link) across a second channel of communications. The query is secured via a proprietary encryption algorithm. Additionally, an SSL connection can be established to enhance security. The Password Client 110 (a communications program dwelling on the subscriber's site) is a TCP/IP communications routine which sends the query. It establishes contact with the Password Verification Server 106. The query is an encrypted message containing the subscriber's identity (for billing and verification purposes), a reply IP address, username and password.

The password verification server 106 contains a communications and database interface. It will receive the Password Client's encrypted message. Then a password database will be searched in order to verify the username/password pair. An encrypted go/no-go (“thumbs up”/“thumbs down”) reply is returned to the Password Client 110 across the second communications channel. This reply can include anonymous demographic information such as specialty, location, and type of practice.

The Password Client 110 at the subscriber's site 104 receives the secure go/no-go signal back from the password verification server 106. The subscriber's Web site 104 admits or rejects the user's request for access to restricted content based on the verification signal received.

Information Flow

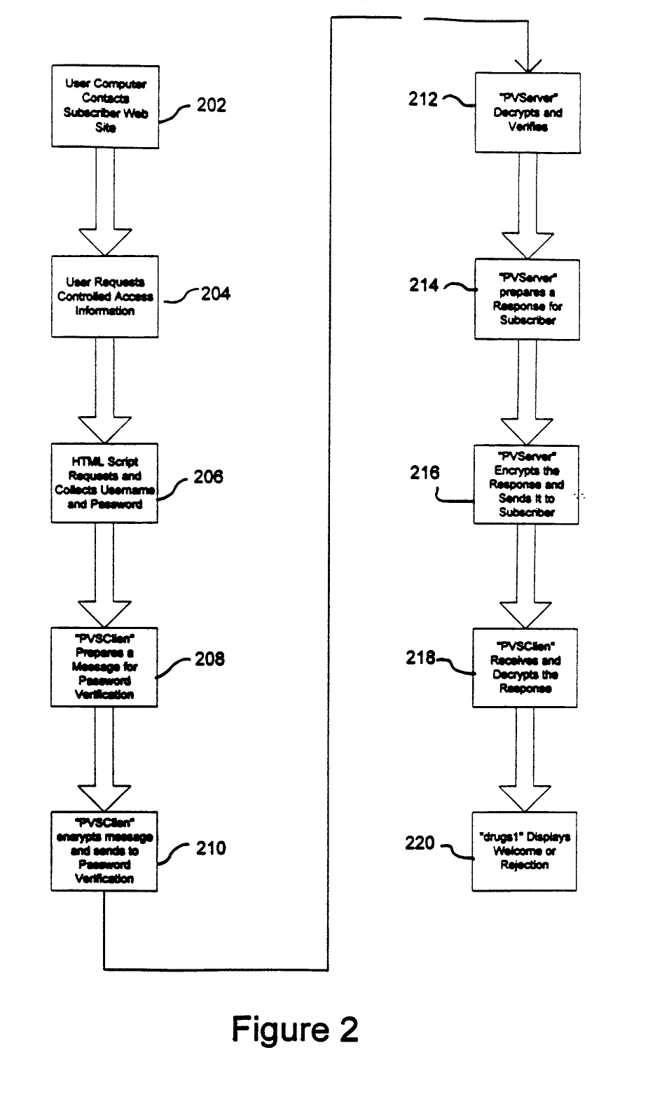

FIG. 2 depicts a flowchart of the method of remote verification. The flow of information of the remote verification system will be explained in relation to the software elements comprising the system. First, in the presently preferred embodiment, a health care professional (or “user”), using a computer, makes contact with a subscribing pharmaceutical or medical device manufacturer's Web site (or “subscribing site”) (step 202) across a first communications channel. Once the user requests information from a controlled access portion of the subscribing site (a health care professionals-only area in the presently preferred embodiment) (step 204), an HTML script requests and collects user name and password information from the user (step 206).

Once the log-on information is collected, a routine, “PVSClien”, prepares a message to send to a password verification server (step 208) across-a second communications channel. In the presently preferred embodiment, the message comprises the collected user name and password, as well as an identifier to the calling site (subscribing site) for billing, the particular calling page, and a time stamp. After the message is prepared, it is encrypted using the proprietary algorithm described below and sent to a password verification server (step 210). Additionally, an SSL connection can be established to enhance security.

At the password verification server, a routine, “PVServer”, decrypts the message and verifies the user name and password received (step 212). In order to decrypt the information, the routine matches the encryption key with the calling site. Once decrypted, the routine looks up the user's record in a verification database. The user record, in the presently preferred embodiment, includes: user name, password, specialty code, zip code, type of practice code, and medical education number.

Once verification has taken place, PVServer prepares a response to send to the subscribing site (step 214) across the second communications channel. This message includes: user name, password, specialty code, zip code, type of practice, and an indication of whether the user is accepted or rejected. The message can also include a short text communication, for example, contact information for users having password problems. Such messages can be tailored to specialty or geography. PVServer then encrypts and sends the response to the subscribing site in a secure manner (step 216). The response is secured via a proprietary encryption algorithm. Additionally, an SSL connection can be established to enhance security. At the subscribing site, PVSClien receives the response and decrypts it (step 218). Another routine, “drugs1”, executing at the subscribing site is responsible for: welcoming or rejecting the user based on the indication and passing demographic information such as specialty, zip, type of practice and ME number to subscribing site (step 220).

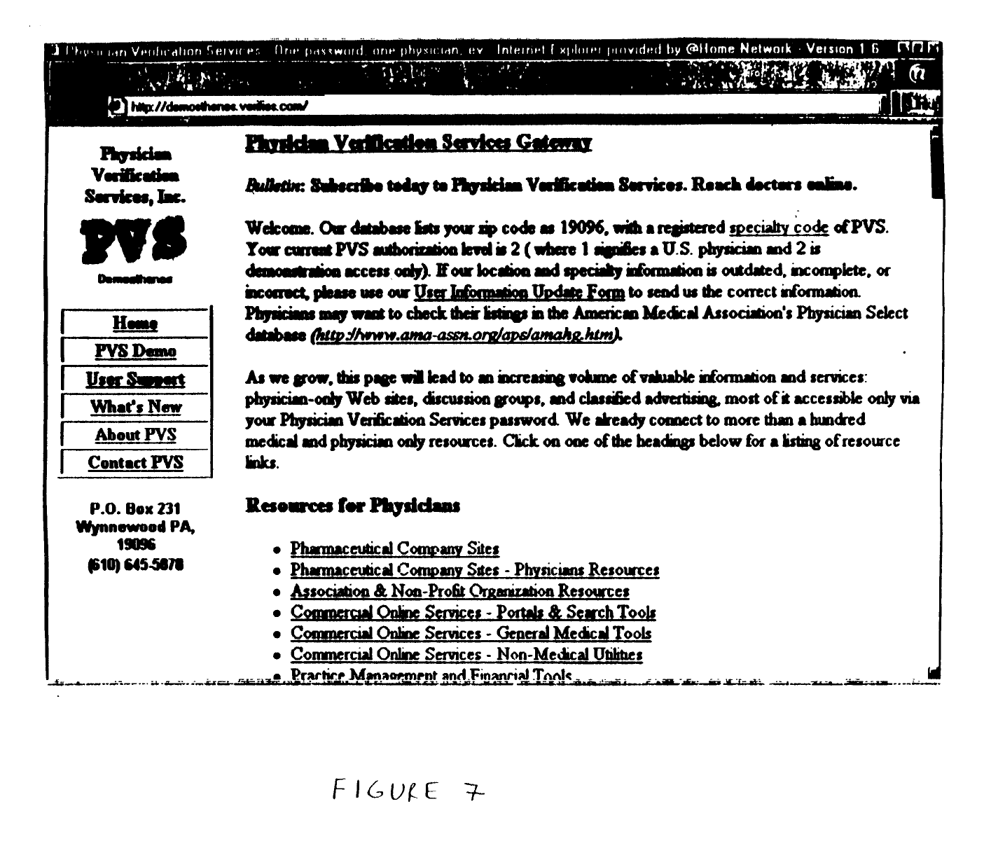

FIG. 7 shows an example of a “Welcome” page. This page welcomes the user and states what PVS has listed as the user's zip code and specialty. There are several links provided to the user. The user may update the PVS files kept on the user, visit the American Medical Association's site, or connect directly to several pharmaceutical company sites.

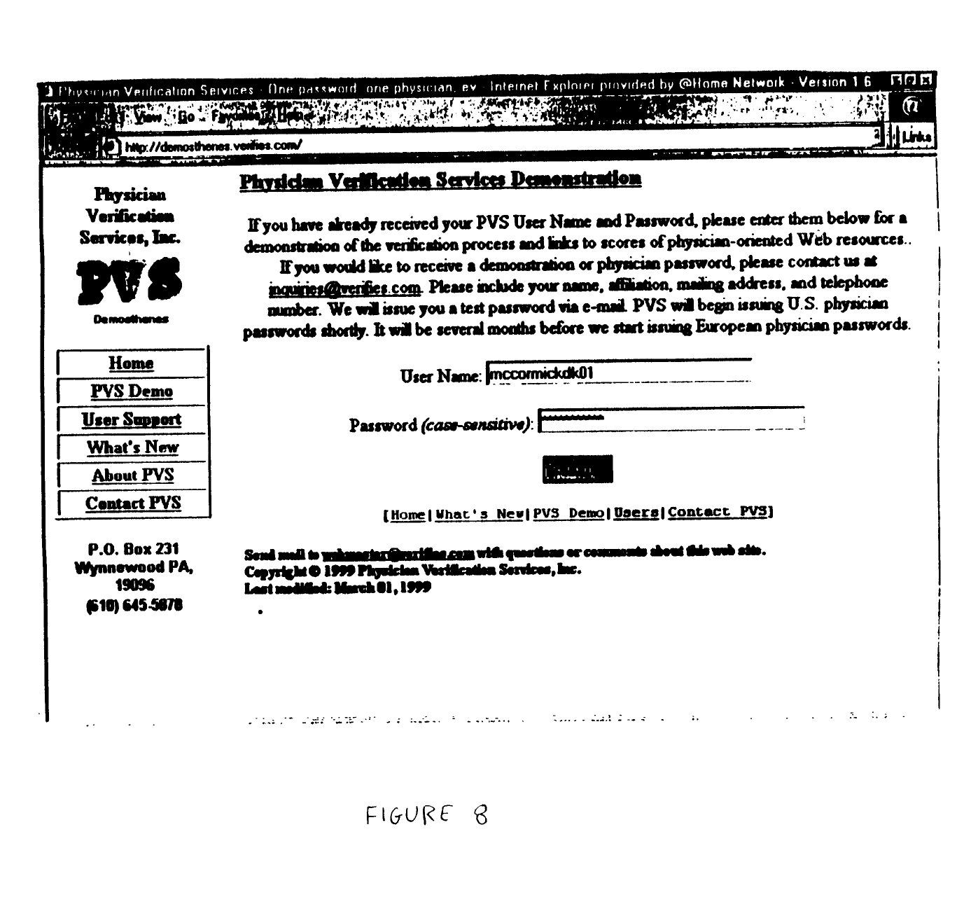

FIG. 8 is a sample “Sign-in” page. Users who are already registered with PVS and have a password and username may use this page to sign in and gain access to limited access areas of pharmaceutical Web sites, and to other PVS “physician only” services. In this example, a demonstration username “mccormickdk01” has been entered in the “username” field. The “password” field shows that a password has been entered as well (represented by asterisks). The user then clicks the “submit” button shown below these two fields, and the username and password will undergo verification. If the identifiers entered match those on the PVS server list of registered users, the user is verified.

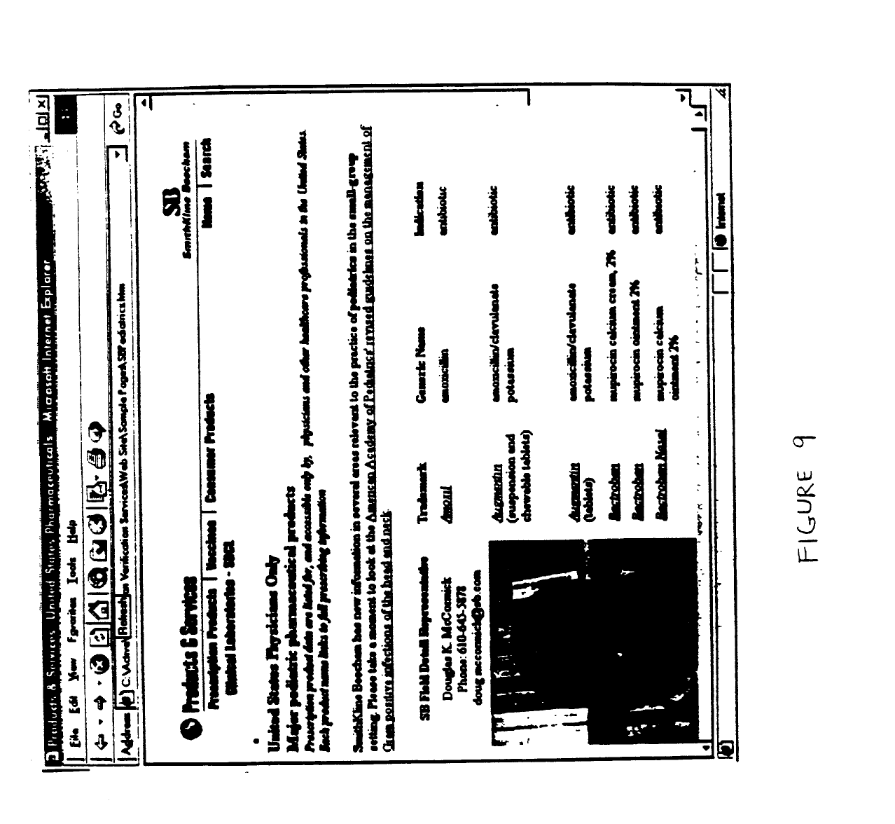

FIG. 9 shows an example of the “pop-up” sales representative page. In this demonstration, the user sees the SmithKline Beecham products and services page, which gives information about pediatric pharmaceutical products. The image of a person is shown, along with contact information. In actual practice, this would be a real SmithKline Beecham field representative whom the user could contact. There is also information about products, with links to full information about each product.

Rapid Registration

In the presently preferred embodiment, the user (a health care professional with certain personal data recorded on the American Medical Association masterfile) wishes to enter the secured area of a subscribing Web site. The user may enter the PVS password and username if the user is registered with PVS. However, some health professionals are not registered with PVS, and will consequently not be able to enter the required identifiers. In this case, the user will be required to complete the Rapid Registration Form which is reached through a hyperlink.

The Rapid Registration Form requests the users first name, last name, middle initial, year of graduation from medical school, state or country of medical school, date of birth (two digit day, two digit month, four digit year), current zip code for main mailing address, and email address. The user will also have the option of registering with Physician Verification Services, and having a username and password sent to the user. This will allow the user to register by entering only these identifiers, rather than the above mentioned information.

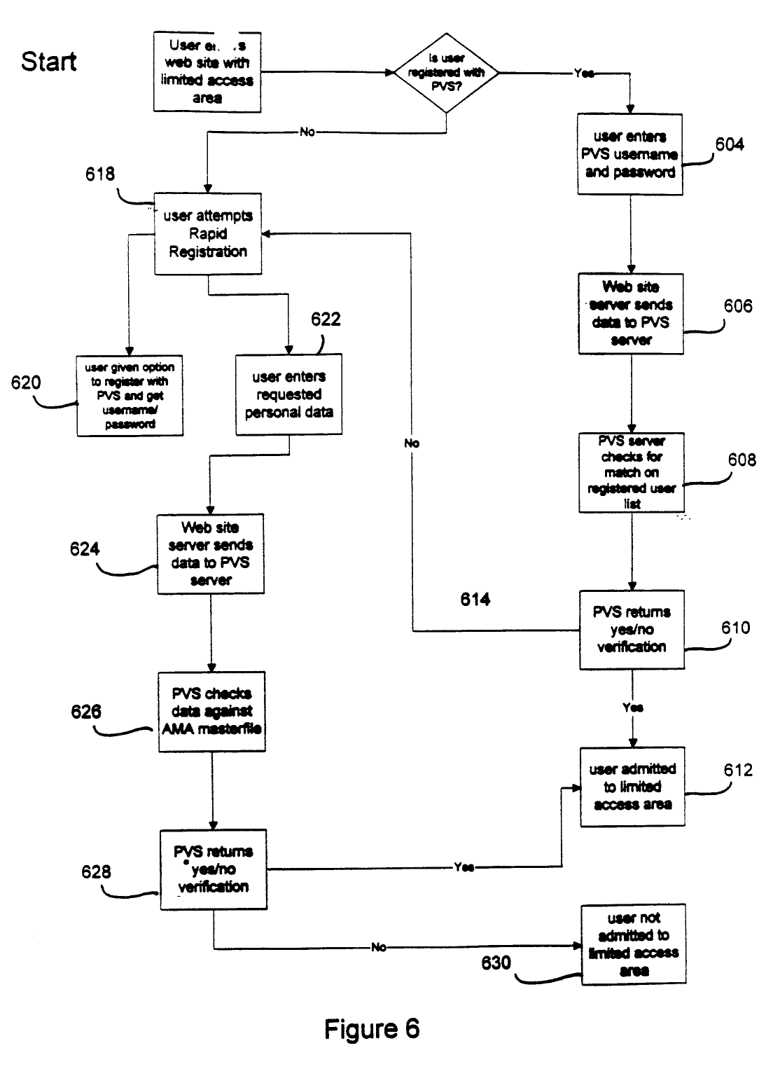

FIG. 6 shows a flowchart of the verification process. In step 602, the user enters a Web site that has limited access areas which require verification of the user's status in order for the user to enter. The user sees both a rapid registration and a registered user option. If the user has preregistered with PVS and already has a PVS password and username, the user enters these identifiers (step 604). The Web site server sends this data to the PVS server (step 606), which checks the data for a match on the PVS registered user lists (step 608). The PVS server then returns a verification of the user's status to the Web site (step 610). If the identifiers match, PVS returns a “yes” verification and the user is admitted to the limited access area (step 612).

If the identifiers entered by the user do not match the PVS registered user list, PVS returns a “no” to the Web site (step 614). If a “no” verification is returned, or if the user otherwise is not registered with PVS, the user may use Rapid Registration (step 618). At this time, the user will also be given the option to register with PVS to obtain a username and password for future use (step 620). At the Rapid Registration Form page, the user is prompted to enter identifying data, including name, year of graduation from medical school, name of the medical school where the user graduated, date of birth, zip code, and email address (step 622). The Web site server sends this data to the PVS server for verification (step 624). The PVS server checks the requested identifiers against the American Medical Association's (AMA's) masterfile (step 626), which is updated periodically on the PVS server. PVS returns a “yes” or “no” verification (step 628). If the data matches that in the AMA masterfile, PVS returns a “yes” verification and the user is admitted to the limited access area (step 612). If the data does not match, PVS returns a “no” verification and the user is not admitted to the limited access area (step 630).

Encryption Algorithm

In the presently preferred embodiment, the encryption algorithm is based on the mathematical principle that:

for any prime P, N^{p} MOD P=N; for all N<P

Based on that result, it can also be shown that

N^{P-1}MOD P=1

N^{P-2}MOD P=1/N

In the presently preferred embodiment, values of P and N are selected to be in the range of 31 to 32 bits in length. Encryption of a message comprises taking three bytes of clear text and appending a fourth byte of random number. A third 32-bit value, A is added to that result and then the entire result is multiplied by N. The result of the multiplication step is then divided by P. The remainder of the division constitutes the encrypted message which will be transmitted over the Internet.

During decryption, the encrypted number is multiplied by 1/N and then divided by P. The value, A, is then subtracted from the remainder. The randomly-generated portions of the result are discarded. The result is the original clear text.

The above method of encryption offers both speed and efficiency. The encryption sends four bytes of encrypted data for every three bytes of plain text. Therefore, there is a relatively smaller (33%) increase in communication volume. Further, encryption and decryption utilize simple mathematical operations allowing for quick processing times.

Preferred Embodiment for Some Operating Systems

The routines which handle password and user-name submission transactions and mediate the interaction with the password verification server-are described above as being implemented with CGI scripts. However, the routines can also be implemented with Internet Server Applications (ISAs) and Filters provided by an Internet Server Application Programming Interface. An ISA is a dynamic-link library (DLL), that is, one or more functions that are compiled, linked, and stored separately from the processes that utilize them. Filters sit between the client and a server and allow special actions to take place. While both CGI scripts and ISAs (and Filters) can perform many of the same services (and all of the same services for the purpose of this application), ISAs and Filters offer certain advantages. The biggest advantage is that an ISA can execute in the same address space as the process that utilizes it. CGI scripts execute as separate processes and therefore require environmental variables to be passed between processes in order for communication to take place. Additionally, since the calling process is aware of the ISA in memory it can purge the ISA if it is no longer needed (or has not been called recently) and can preload it for faster execution when called. Any operating systems which supports loadable shared images, such as Windows NT™ for example, can utilize ISAs and Filters.

Detail of a Sample Preferred Embodiment

Following is a detailed description of the processes and performance of the PVS1 ISAPI Application Extension and PVS1 ISAPI Filter.

The PVS1 ISAPI Application Extension

The PVS1 ISAPI Application Extension is the first element in the verification chain offered by Physician Verification Services (PVS) on Web servers utilizing Microsoft Windows NT and the Microsoft Internet Information Server (IIS). Specifically, this program lives on a Web server where there is information that needs to be protected, for example, the Web server of a pharmaceutical company.

In the sample embodiment, the PVS1 ISAPI Application Extension resides in the PVS1.DLL file. Because it is an executable, it is found in a folder that must be flagged as executable by the IIS. This executable code is fired off when, for example, a doctor seeking protected information arrives at the gateway HTML page and fills in the UserName and Password fields of a form and clicks the Submit button.

For example, in a sample structure, the gateway HTML page is found at C:\InetPub\wwwroot\pvs1\password.htm. The executable, in the set of sample files, is found at C:\InetPub\wwwroot\pvs1\PVS1.DLL.

It should be noted that the directory structure here is just an example. It actually can be any arbitrary setup, provided that all of the references and pointers remain consistent.

The PVS1 ISAPI is invoked after the PVS gateway password HTML page is shown to a person browsing for protected information. The person first enters his or her UserName and Password in the appropriate fields. When the Submit button is pressed, the PVS1.DLL ISAPI Application Extension is fired off, and the user-supplied data is passed to the PVS1.DLL.

The PVS1 ISAPI Application extension first checks to see that neither of the UserName or Password fields are empty. If either is empty, the user is shown an error message. Otherwise, the application extension sends the password verification request off to the PVS password server. In order to do this, it needs some additional information, which it gets from a file location hardwired into the PVS1.DLL program. In the sample embodiment, that file location is C:\PvsClient\pvs1.ini. That folder and that file name must exist on drive C: for the program to work properly. The contents of the initialization file will be described later.

Based on the response from the server, the Application Extension displays either an error or a welcome message. Both of those are derived from HTML templates, which will be described below. Appropriate entries are made in a log file, also to be described below. If the user has given a correct UserName/Password pair, that user will be issued an HTTP cookie, which will allow the server to identify the user during subsequent HTML requests.

The PVS-issued cookie is valid for four hours. HTML requests for protected information from that computer will be honored during that time period. Any subsequent requests will result in the user's browser being directed once again to the password page.

The server's behavior when a user attempts to access a protected site is governed by the other part of the PVS1.DLL program: The PVS1 ISAPI Filter.

The PVS1 ISAPI Filter

The filter portion of the software is a part of the PVS1.DLL which gets loaded at the same time as Internet Information Server. As its name suggests, the PVS1 ISAPI Filter examines every HTML request that passes through the IIS WWW server. If any URL maps to a folder that has the string “\PRI” in its path name, the PVS1 ISAPI Filter regards the information contained in that folder to be protected. If the URL mapping doesn't contain that string, the filter takes no action at all.

If the folder does contain “\PRI” (incidentally, the test for “

PRI” is not case-sensitive) then the filter checks to see if there is a valid PVS-issued cookie in the HTML request headers. If not, then the user's browser is shown an HTML file named NotYet.htm in the folder immediately above the “\PRI” folder in the directory tree.

If there is a valid cookie, the filter next checks to see if the user's Authorization Bits (which came from the server and were stored in the cookie) match the authorization bits of the protected folder.

A folder's authorization bits are appended to the folder's name in a hexadecimal scheme. The hexadecimal decoding starts immediately after the “\PRI”. Hyphens are ignored and can be used to make the code more readable; any other character terminates the string.

A folder with no authorization bit code string can be accessed by any verified user.

If the user's Authorization Bits do not match the string appended to the folder name, the user is presented with the HTML page NotAuthorized.htm in the folder immediately above the “\PRI” folder in the directory tree.

Finally, if the validated user's authorization bits match the folder's, then the user is presented with the HTML page that was originally requested. The “cookie jar”

Every time the PVS1 ISAPI Filter allows access to a protected file based on the user having a valid cookie and matching authorization bits, it makes an entry in what we call the cookie jar. The cookie jar maintains a list of the most recent UserNames to access protected files, and how many hits there were. Periodically the filter empties the cookie jar, sending a notification off to the PVS server that it did so.

Password verification requests, the responses from the PVS server, and cookie jar dump are all logged in a PVS log file on the client server. The log file is described below.

Contents of the PVS1.INI File

As mentioned earlier, the PVS1 ISAPI Application Extension and the PVS1 ISAPI Filter need some site-dependent information in order to function. Rather than build such information into the software, it is kept in an initialization file. Here is a sample C:\PVSCLIENT\PVS1.INI file:

[pvsl]

SiteID=“TestSite”

PasswordServer=“demosthenes. verifies.com

”

TemplateRoot=“c:\inetpub\wwwroot\pvs 1 \cgi-bin”

LogRoot=“c:\pvsclient”

ServerTimeout=5000

Here is what each line means:

[pvsl]—Bookkeeping for the system routines which extract information from the file.

SiteID—This is your site's identifier, so that PVS can figure out where the request came from. PVS will issue this code, and it should not be altered.

PasswordServer—This is the name of the computer that processes verification requests.

TemplateRoot—There are a number of different possible responses that the PVS1.DLL program can generate. Those responses are derived from HTML templates and the template root tells the PVS1.DLL program where to find those templates. You will probably alter this to match your own Web page directory structure. This can be altered to match a particular web page directory structure.

LogRoot—the PVS1.DLL program generates a log of its activity. That log has some information which might be useful to you, and it too will be discussed later. The LogRoot specifies the folder where the log files are to be stored.

ServerTimeout—the number of milliseconds the program waits for a response from the server before resending the request. After four resends it gives up and tells the browser that there was no response. Setting the timeout to 5000 means that the browser will get an error response after twenty seconds.

Information Found in the Log Files.

In the sample embodiment, the log files are maintained in the folder c-log.txt in the folder specified by the LogRoot entry of the c:\pvsclient\pvs1.ini file. The c-log.txt file is only allowed to grow to be 1,000,000 bytes in length, at which point it is renamed c-logl.txt. At that same time, any file already named c-logl.txt replaces any file already named c-log2.txt. In this fashion, between two and three million bytes of history are maintained, but in a way that doesn't just keep growing forever.

The information in the log files is kept for two reasons. First, it will help in tracking down problems, should there be any. Second, the information is available to the site administrators for review and analysis.

The log file contains a handful of different possible entries. Each line contains a number of different fields, which are identified by number and separated by <tab> characters.

The table of numeric codes (not all of which will be seen in any one c-log.txt entry) is this:

```
PVS Parameter Values
  1
TIMESTAMP
YYYYMMDDHHMMSS.SSS UTC
  2
VERSION
Version code of client software
  3
USER_ID
The UserName
  4
PASSWORD_QUERY
Outgoing password
  5
PASSWORD_OK
Response from server
  6
PASSWORD_NG
Response from server
  7
PHARM_SITE
Site code from the PVS1.INI file
  8
SERVER_NAME
Computer name of the client server
  9
REMOTE_HOST
As reported by the HTTP headers
10
REMOTE_ADDRESS
As reported by the HTTP headers
11
TABLE
Indicates in which PVS table a UserName was found
13
COUNTRY
From the UserName's address
14
ZIPCODE
From the UserName's address
15
SPECIALTY
UserName's AMA self-designated medical specialty*
16
TOP
UserName's AMA type of practice*
18
CITY
From the UserName's address
19
STATE
From the UserName's address
20
SYSTEMMESSAGE
HTML text string from the PVS Server
21
COOKIE_JAR
A cookie-jar dump
22
FLAGS
Flags from client to PVS server (not yet implemented)
23
TIMEOUT
Indicates that the server didn't respond to a password request
24
MPA
UserName's AMA Major Professional Activity*
25
PRIMARYPE
UserNames AMA Primary Employment*
26
AUTHORIZATIONBITS
Username's Authorization Bits
*These are standard codes used by the American Medical Association in its Physician Masterfile. PVS provides interpretive tables where required.
```

A very typical one is the Password Request entry:

1=19990505210552.972 2=1 3=davisr01 4=******* 22=0 7=TestSite 8=xanadu.verifies.com 9=10.149.10.100 10=10.149.10.100.

This line is interpreted as follows: It means that at May 5, 1999 at 21:05:52.972 Universal Time a password request was initiated by software version 1. It indicates that

* the username is “davisr01”,

* this is a password verification request,

* the flags for this transaction are 0,

* the SitelD from the pvs1.ini file is “TestSite”,

* the server's name is “xanadu.veries.com”,

* the remote browser's host name is “10.149.10.100”

* and the remote browser's IP address is “10.149.10.100”.

There are a several possible responses which could follow this request entry in the log. If the PVS server is not responding, the response will be repeated three additional times, and will then be followed by 1=19990505212552.474 23=TIMEOUT

If the PVS password server doesn't recognize the UserName or the Password the response would look something like this:

1=19990505210553.457 3=davisr01 6=NG

If the PVS password server does recognize the UserName and password, the response is more extensive:

1=19990505210553.457 3=davisr01 5=OK 11=1 13=USA 14=35401 15=GP 16=020 18=TUSCALOOSA 19=AL 24=OFF 25=011 26=1

The decode of this entry:

At May 5, 1999 at 21:05:53.457 UTC this response for UserName “davisr01” was received. It indicates that

* the UserName was found in PVS Table 1 (which is the AMA data file),

* the country is “USA”,

* the ZIP code is “35401”,

* the AMA specialty is “GP”,

* the AMA Type of Practice is “020”,

* the City is “TUSCALOOSA”,

* the state is “AL”,

the AMA Major Professional Activity is “OFF”,

the AMA Primary Employment is “011”

and the PVS Authorization Bits for this user are “1”.

Another possibility for a c-log entry is a dump of the cookie jar. Such an entry would look like this:

1=19990505211017.002 2=1 7=TestSite 8=xanadu.verifies.com 21=davisr0,1,3;

As before, this entry identifies the time, the software level, and the location. (Perhaps it should be emphasized that on any one server, the “7=” and “8=” entries will always be the same. But this is a copy of the information being sent to the PVS Password server, and those fields serve to identify where the information is coming from.) The “21=” entry consists of UserName/count pairs separated by semicolons. This entry indicates that since the last cookie jar dump, UserName “davisr01” accessed three protected pages.

PVS HTML Templates

In the sample embodiment, there are a number of HTML files which need to exist or be generated in order for the verification process to be accomplished.

The PASSWORD.HTM file

This file doesn't have to have any particular name. It can be found in any number of places in a Web site's structure (provided that they are not “\PRI” locations), and, indeed, doesn't have to have any particular form except that the data form must match the one on the PVS sample. Its purpose is to invoke the PVS1 ISAPI Application Extension and generate a request to the PVS Password Server.

\TemplateRoot\needpw.htm

As its name suggests, this file must be found in the TemplateRoot specified in the C:\PVSCLIENT\PVS1.INI file. This page gets displayed by the PVS1 ISAPI Application Extension when either the UserlD or the UserID2 fields from the PASSWORD.HTM page are empty when the Submit button is clicked.

\TemplateRoot\timeout.htm

This page is displayed to the user when the HTML server is unable to get a response from the PVS Password Server. The PVS1 ISAPI Application Extension will try four times at intervals specified by the ServerTimeout parameter in the PVS1.INI file.

\TemplateRoot\pwnogood.htm

This page is displayed to the user when the PVS Password Server sends back a “Not Verified” response.

\TemplateRoot\pwokay.htm

This page is displayed to the user when the PVS Password Server sends back a “Username/Password verified” response.

\Path\NotYet.htm

There can be any number of NotYet.htm files; there must be one in each folder that has a subfolder named “\PRI”. The \path\NotYet.htm file is displayed when an unverified user attempts to access a Web page stored in a folder below \path\pri\.

\Path\NotAuthorized.htm

Similar to the \path\NotYet.htm file, this one is displayed when a verified user attempts to access a “\PRI-xx” folder when the user doesn't have an Authorization Bit which matches the hexadecimal “-xx” code of the folder. There must be one such NotAuthorized.htm file in each folder immediately above each \path\pri-xx\folder.

HTML Template Customization

Each site can put whatever HTML information might be desired into the various template HTML files. The PVS template files can be modified slightly based on the information that comes back from the PVS Password Server.

The modification is based on replacing a particular unusual text string (“!=DUBNER”) in the HTML template files with the numerically-coded response data from the PVS Password Server. As a specific example, the pwokay.htm file might contain the following HTML text string:

The password entered with User ID !=DUBNER3 was determined to be correct. You are located in !=DUBNER18, !=DUBNER19 DUBNER14. The system message for today is !=DUBNER20.

The actual text that would be generated and seen by the user would have the various !=DUBNER fields replaced by their numerical equivalents as reported by the PVS Password Server, specifically, they would be replaced by the UserName, the City, State, and ZIP code, and the system message.

Having described the system in that detail, it might be useful to summarize it graphically:

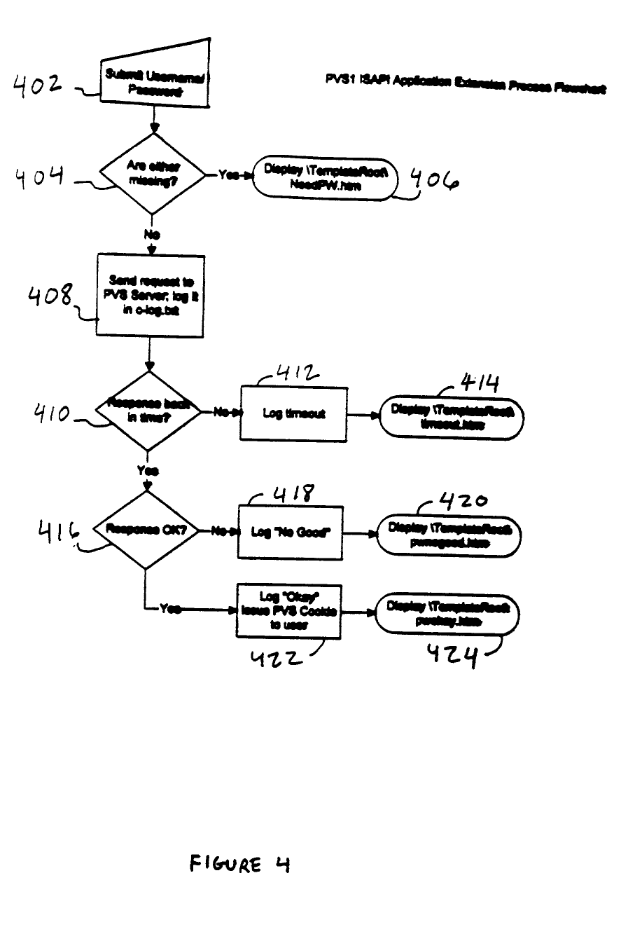

When a user clicks “Submit” on the password page, it starts the PVS1 ISAPI Application Extension: Please refer to FIG. 4, the PVS1 ISAPI Application Extension Flowchart.

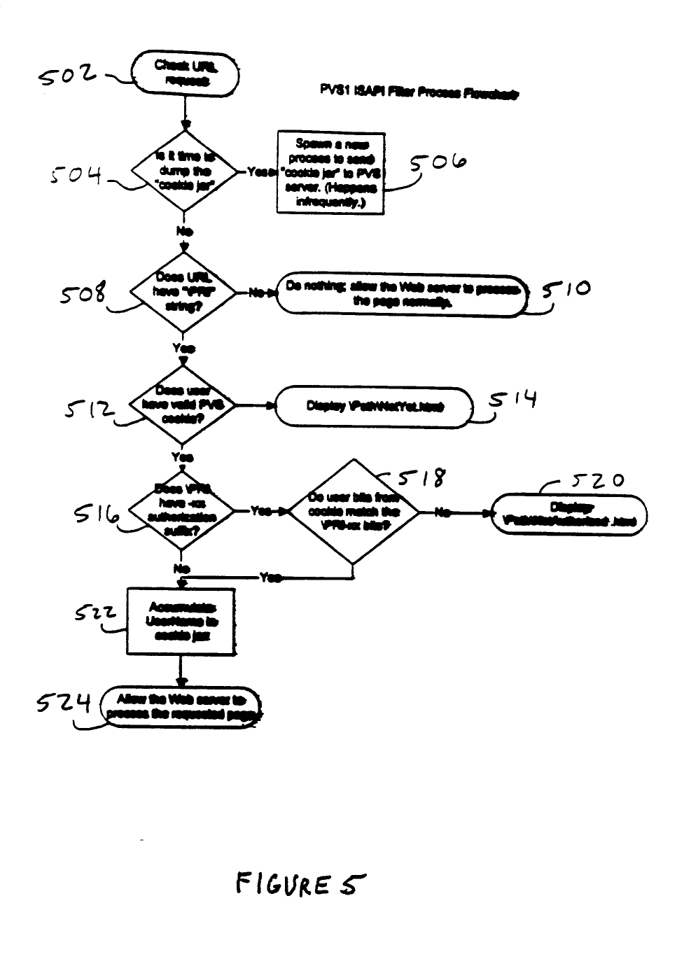

Meanwhile, the PVS1 ISAPI Filter is checking every URL request that the server receives, as shown in FIG. 5.

While following these flowcharts, it should be kept in mind that many events are controlled by information found in the C:\PVSCLIENT\PVS1.INI initialization file, and that many of the events are logged in the \LOG ROOT\C-LOG.TXT file as they occur.

FIG. 4 begins with the user submitting a username and a password (step 402). The application extension checks for missing identifiers (step 404). Missing identifiers prompt an error message display (step 406). Otherwise, the request is sent to the PVS Server (step 408). If a response is not returned in the allotted time (step 410) then the timeout is logged (step 412) and displayed (step 414). If the response is timely, it is checked for a match in the database (step 416). A non-match will return a “no good” display (steps 418 and 420). If the response is OK'd, a PVS cookie is issued to the user (step 422) and an acceptance message is displayed (step 424).

FIG. 5 shows the PVS1 ISAPI Filter Process. First the URL request is checked (step 502). If it is time to dump the cookie jar (step 504) then a new process to send a cookie jar to the PVS Server is spawned (step 506). If it is not time to dump the cookie jar, the URL is checked for a “\PRI” string (step 508). If not, then the Web page is processed normally (step 510). If so, the user is checked for a valid cookie (step 512). If the user has no valid cookie, the filter displays the \Path\NotYet.html (step 514). If the user still has a valid cookie, then the filter checks the \Pri for -xx authorization suffix (step 516). If there is a suffix, then the user's cookie bits are checked against the \Pri-xx bits (step 518). If they do not match, then a non-authorization page is displayed (step 520). If they do match, then the username is accumulated in the cookie jar (step 522). The Web server is then allowed to process the requested page (step 524).

System Context

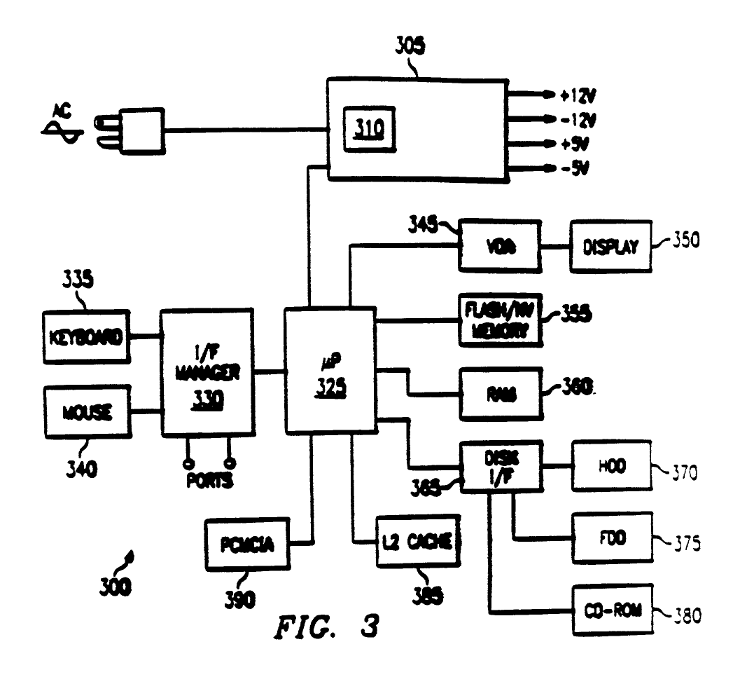

FIG. 3 shows a block diagram of a computer system 300 which can be used for implementation of the presently preferred embodiment. In this example, the computer system, includes:

user input devices (e.g. keyboard 335 and mouse 340);

at least one microprocessor 325 which is operatively connected to receive inputs from said input device, through an interface manager chip 330 (which also provides an interface to the various ports);

a power supply 305 which is connected to draw power from AC mains and provide DC voltage to the computer system 300 components;

a memory (e.g. flash or non-volatile memory 355 and RAM 360), which is accessible by the microprocessor;

a data output device (e.g. display 350 and video display adapter card 345) which is connected to output data generated by microprocessor; and

a magnetic disk drive 370 which is read-write accessible, through an interface unit 365, by the microprocessor.

In the presently preferred embodiment, the routines described which execute the method reside in RAM 360 and are executed by the microprocessor 325.

Optionally, of course, many other components can be included, and this configuration is not definitive by any means. For example, the computer may also include a CD-ROM drive 380 and floppy disk drive (“FDD”) 375 which may interface to the disk interface controller 365. Additionally, L2 cache 385 may be added to speed data access from the disk drives to the microprocessor, and a PCMCIA 390 slot accommodates peripheral enhancements.

Alternative Embodiment

In addition to verification services, the password verification server 106 and the Password Client 110 can be configured to be in constant communication. Such communication will allow messages other than short text messages to be displayed to health care professionals. For instance, the system can operate as a rapid-notification service for users, passing messages of particular importance to a particular user once it is known that the user is connected with a particular subscribing site.

Alternative Embodiment

In an alternative embodiment, the function of the verification services described can be extended to digital signature-like verifications. For example, prescription orders can be delivered on-line to mail order or local pharmacies. The use of such a verification and delivery service would help to eliminate the need for both a paper prescription, which can be forged or lost, and faxing between a physician's office and a pharmacy. In addition, the time for a delivery of a mail-order prescription can be reduced due to the immediate delivery of the prescription authorization to the mail-order pharmacy via the Internet.

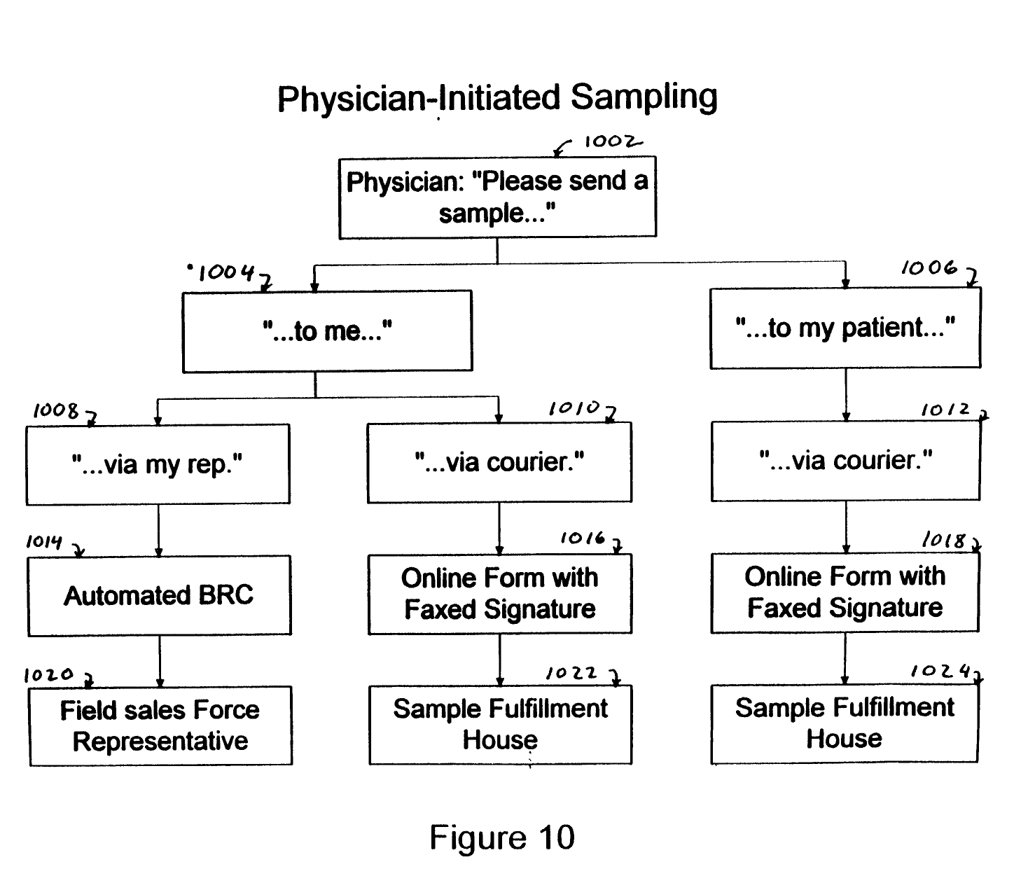

FIGS. 10 depict the present process of physician-initiated sampling. The physician requests a sample requiring verification of the physicians identity and status as a licensed physician (step 1002). The sample is to be sent to the physician (step 1004) or to a patient (step 1006). If sent to the physician, it is to be sent either by the physician's field sales representative (step 1008) or by courier (step 1010). Patient deliveries are by courier (step 1012) in this model. If sent by sales representative to the physician, an automated business reply card (BRC) is used (step 1014). This is a system that produces an electronic form with fields for the physician's information needed by the pharmacy. The BRC is returned to the pharmaceutical company for action by the field sales force representative (step 1020), who does the actual distribution of the sample.

If the sample is to be sent to the physician or patient via courier, then an online form with faxed signature is used. An online form with the relevant physician's information (step 1016) or with the physician's and the patient's information (step 1018) is sent directly to a sample fulfillment house (a pharmaceutical company or an agent of one), who distributes the samples to the doctor (step 1022) or the patient (step 1024). The online form has fields for the physician's (or the physician's and patient's) information like the BRC, but also generates a form for the doctor's signature to be returned to the pharmacy by fax. The physician fills in the relevant fields of the electronic form, which creates a suspense file at the fulfillment house, awaiting a faxed signature by the doctor. Once complete with signature, the samples are sent.

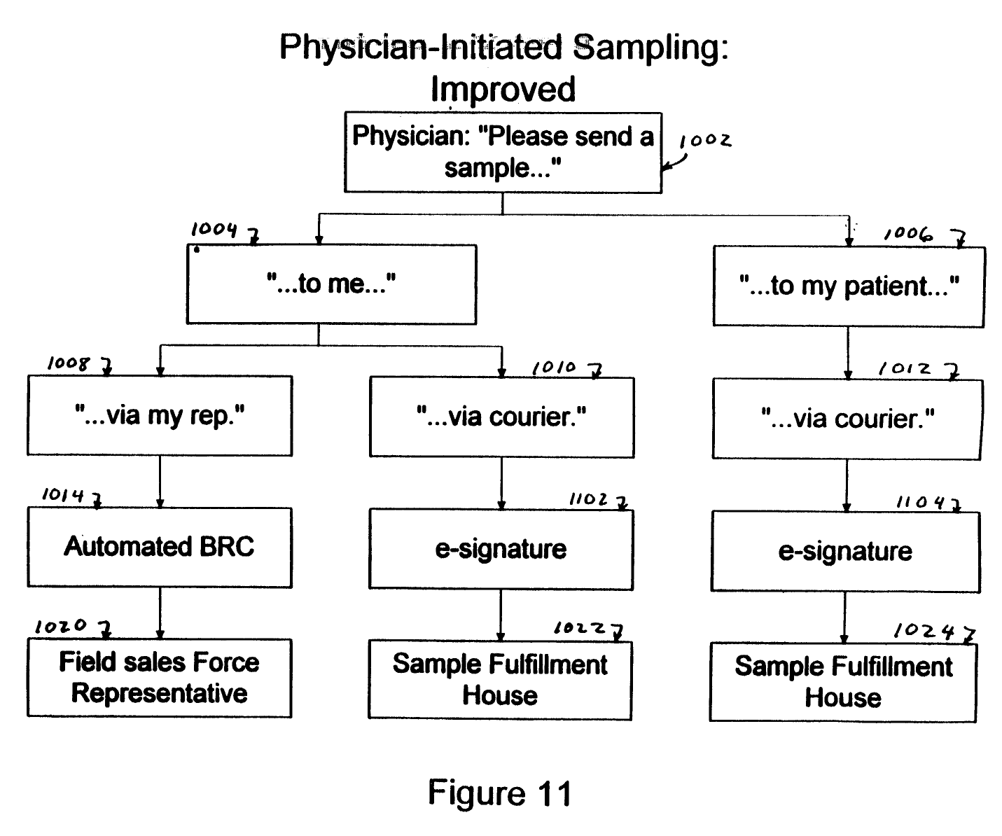

In many jurisdictions, an actual signature is required for the legal ordering of prescription drugs. The presently disclosed embodiments of the invention creates an alternative to this method of verification by substituting an “e-signature” for the online form and faxed signature. FIG. 11 shows the same process for physician-initiated sampling, but steps 1016 and 1018 are replaced by steps 1102 and 1104—using e-signatures instead of faxed signatures. The presently disclosed embodiments of the invention, by verifying the identity and status of a computer user as a physician, obviates the need for a faxed signature.

Though presently this would not fulfill any legal requirements for an actual signature, it would fulfill proposed rules for electronic signatures proposed in the Federal Register, Wednesday, Aug. 12, 1998, p. 43241, “Department of Health and Human Services, Office of the Secretary, 45 CFR part 142, Security and e-signature Standards; Proposed Rule.” These proposed requirements suggest standards for e-signature ordering of prescription drugs. The three primary requirements are message integrity, non-repudiation, and authentication. Message integrity means that the message cannot be tampered with or viewed by non-intended recipients. This can be fulfilled by using a secured sockets layer (SSL) in the communication. Non-repudiation (meaning a user cannot deny having sent the message) and authentication (verifying the origin of the data) are achieved by the disclosed embodiments of the present invention. Thus, the present invention coupled with an SSL fulfills the three criteria of the proposed e-signature standards.

Alternative Embodiment

In an alternative embodiment, the user first visits the PVS Web site and enters the PVS username and password. From there, the user can link directly to the controlled access areas of physician only Web sites with hyperlinks on the PVS site. The hyperlinks to limited access areas from the PVS site may be reached after logging in at the PVS site with the PVS username and password. These hyperlinks will then take the user directly to the limited access areas, without having to go through the PVS verification again.

Alternative Embodiment

In another alternative embodiment, subscribing Web site servers may retain passwords and usernames locally in their storage. This allows faster verification, eliminating the need to directly access PVS for every verification. Frequent or recent visitors to a Web site may be verified with the local memory of their usernames and passwords. The subscribing Web sites are prevented from seeing the personal data of the users either by contract or by PVS software stored locally designed to prevent access.

According to a disclosed class of innovative embodiments, there is provided: A business method of facilitating communication between health care professionals and subscribing Web sites, the Web sites containing secured areas, comprising the steps of: when the health care professional attempts to access said secured areas of the subscribing Web sites, allowing said health care professional to either provide previously assigned identifiers, or provide other identifying data; verifying said previously assigned identifiers or said other identifying data; allowing said health care professional access to said secured area upon verification of said previously assigned identifiers or said other identifying data.

According to another disclosed class of innovative embodiments, there is provided: A business method of facilitating communication between health care professionals and subscribing Web sites, comprising the steps of: when access to controlled information is requested from a subscribing site by one of said professionals, requesting verification from a secure server site which has an authorization list, and if said secure server site provides said verification, then permitting access, while concealing sufficient information about said professionals to preclude said subscribing sites from initiating solicitations of said professionals, wherein said verification is achieved by comparing personal data entered by the professional to data on said authorization list.

According to another disclosed class of innovative embodiments, there is provided: A business method of brokering privacy for access to controlled information by licensed professionals, said controled information contained on subscribing Web sites, comprising the steps of: when said professional attempts access to said controlled information, permitting said subscribing sites to obtain short-term verification of authorization for said professional to access said controlled information, with reference to a database that is not accessible to said subscribing site and is kept on a secured server; comparing personal data entered by said professional to data kept on said database; and preventing said subscribing site from accessing the data entered by said professional; wherein said professional need not be preregistered on said secure server or be issued a username or password by said secure server.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

In the presently preferred embodiment, a method and system of physician verification are disclosed. However, these services will support not only marketing of regulated products to physicians, but also on-line Continuing Medical Education, professional publishing on-line for physicians, and recruitment for clinical trials. In addition, any type of controlled access information can make use of the remote verification system and method described herein.

In the presently preferred embodiment, a proprietary encryption algorithm is described. However, there are many encryption schemes available such as PGP, RSA, etc. Most if not all of these encryption schemes can be adapted for use with the system and method described herein.

Optionally, secure locking relationships (public-key relationships) can be used to completely prevent vendors from cracking the PVS front-end software and gaining access to the secure data.

In another contemplated alternative, the professionals accessing a vendor site can be allowed to simply click on a button to give the vendor their complete identification data.

A computer system for implementation of the presently preferred embodiment is described. The hardware which comprises the system can be any combination of available processors and operating systems. Such systems can include, for example, Unix boxes, IBM PC compatible, and Macintosh computer systems. Such a computer, either singly or networked together can be used for 102, 104, and 106.

Additional Modifications

An additional modification of the present innovations provides each physician with two passwords for each username. One of the passwords is designated as the doctor's private password. The second password, the “staffword,” is available to the doctor's office staff. The physician's private password is required for all administrative and high-security medical transactions. The staffword is usable by office staff properly delegated to perform support work for the practice.

A further modification includes rapid identification. Rapid identification allows quick login for physicians who have forgotten their passwords, or for physicians who are not yet part of the system. It allows qualified users to gain one-time access to lower security areas by submitting some personal data. Their data is compared in real time with data on the provider's database. A successful match gives the user immediate access to the local resources, but does not enable the user to access other gated content. This feature can be enabled or disabled by the subscribing web site. It can also be disabled at the password server.

This, coupled with the normal login procedures (which require the physician to enter the identifiers provided by PVS) creates a two-tier authentication system that offers both reliable authentication for high-security areas and easy entry for new users or those who have forgotten their identifiers.

A further modification includes a virtual prescription pad. Virtual prescription pad provides user and message authentication to fulfill regulatory requirements for electronic signatures in health care. It combines SSL security for message integrity with PVS central password verification for user authentication and “non-repudiation,” which lets doctors identify themselves and sign prescriptions on the Internet.

A further modification integrates digital certificates with central authentication. The central authentication system is integrated with the virtual-prescription pad and digital certificates to provide a continuum of appropriate security for health care applications, allowing users to move from application to application with the minimum of inconvenience, while still allowing subscribers to make use of the optimum level of identification at the minimum cost.

A further modification includes video conferencing. PVS and its Internet broadcasting partner arrange physician-only audio and video events on the web using the PVS authentication system. Invitations and admission checking are handled by PVS (via direct mail, email, or field-force delivery, for example). The server will deliver audio, video, and slides (live or pre-produced) and can repeat the program on demand for any physician at any time during the contracted run period (typically 30 days).

What is claimed is:

1. A business method of facilitating communication between health care professionals and subscribing Web sites, the Web sites containing secured areas, comprising the steps of:
when the health care professional attempts to access said secured areas of the subscribing Web sites,
allowing said health care professional to either provide previously assigned identifiers, or provide other identifying data;
verifying said previously assigned identifiers or said other identifying data;
allowing said health care professional access to said secured area upon verification of said previously assigned identifiers or said other identifying data,
while concealing sufficient information about said professionals to preclude said subscribing sites from initiating solicitations of said professionals.

2. The business method of claim 1, wherein said previously assigned identifiers or said other identifying data are verified by a separate server that does not contain said subscribing Web site.

3. The business method of claim 1, wherein if said health care professional does not enter previously assigned identifiers, said health care professional is allowed to request assignment of identifiers for future verification.

4. The business method of claim 1, wherein said secured areas contain information which is regulated by a regulatory agency.

5. A business method of facilitating communication between health care professionals and subscribing Web sites, comprising the steps of:
when access to controlled information is requested from a subscribing site by one of said professionals,
requesting verification from a secure server site which has an authorization list, and
if said secure server site provides said verification, then permitting access,
while concealing sufficient information about said professionals to preclude said subscribing sites from initiating solicitations of said professionals,
wherein said verification is achieved by comparing personal data entered by the professional to data on said authorization list.

6. The business method of claim 4, wherein said access is permitted for a limited time only.

7. The business method of claim 4, wherein said data on said authorization list is obtained from the American Medical Association masterfile.

8. The business method of claim 4, wherein said professional is not pre-registered with said secure server site.

9. A business method of brokering privacy for access to controlled information by licensed professionals, said controled information contained on subscribing Web sites, comprising the steps of:
when said professional attempts access to said controlled information,
permitting said subscribing sites to obtain short-term verification of authorization for said professional to access said controlled information, with reference to a database that is not accessible to said subscribing site and is kept on a secured server;
comparing personal data entered by said professional to data kept on said database; and
preventing said subscribing site from accessing the data entered by said professional; p1 wherein said professional need not be preregistered on said secure server or be issued a username or password by said secure server.

10. The business method of claim 8, wherein said subscribing site is prevented from using information obtained from said professional to launch solicitations to said professional, under at least some circumstances.

11. The business method of claim 8, wherein said verification occurs via encrypted communication.

12. The business method of claim 8, wherein anonymous information about said professional is also sent to said subscribing site upon verification.
